(19) United States
(12) Patent Application Publication
(10) Pub. No.: US 2009/0113808 A1
(43) Pub. Date: May 7, 2009

(54) SECURITY WINDOW

(75) Inventor: Nelson Nieves Zeno, Arroyo, PR (US)

Correspondence Address: CARTER, DELUCA, FARRELL & SCHMIDT, LLP, 445 BROAD HOLLOW ROAD, SUITE 420, MELVILLE, NY, 11747, US

(73) Assignee: World Engineering Solutions Corp., Arroyo, PR (US)

(21) Appl. No.: 12/262,864

(22) Filed: Oct. 31, 2008

Related U.S. Application Data
(60) Provisional application No. 61/001,754, filed on Nov. 2, 2007.

(51) Int. Cl. E06B 5/11; E06B 9/80

(52) U.S. Cl. 49/449; 52/204.5

(57) ABSTRACT

A security window for shielding a secured space from forceful attacks includes a fixed lateral profile, a pane, a pane profile movably mounted on the fixed lateral profile, and a locking mechanism is configured to secure the pane profile to the fixed lateral profile. The pane profile supports the pane and is adapted to move the pane between open and closed positions. The locking mechanism has locked and unlocked positions and includes a movable profile adapted to slide longitudinally and transversely with respect to the fixed lateral profile. The movable profile is positioned between the fixed lateral profile and the pane profile when the locking mechanism is in the locked position. When the locking mechanism is in the unlocked position, the movable profile is located inside the pane profile.

### CROSS-REFERENCE TO RELATED APPLICATION

The present application claims priority to, and the benefit of, U.S. Provisional Patent Application Ser. No. 61/001,754, filed on Nov. 2, 2007, the entire contents of which are hereby incorporated by reference.

### BACKGROUND

1. Technical Field

The present disclosure relates to windows for stationary structures such as buildings and homes. More particularly, the present disclosure relates to security windows having impact-resistant properties.

2. Background of Related Art

Over the years, security windows have been developed for a number of purposes. Some security windows are specifically designed to impede forced entry or penetration by projectiles. Other security windows are capable of resisting hurricane force winds. Regardless of its specific objective, security windows usually provide a higher level of protection than regular windows.

A conventional security window includes a framework supporting reinforced panes. Typically, glass and plastic layers form the reinforced panes. Some of the reinforced panes have at least one plastic reinforcing layer and a number of glass layers. One type of security window uses a special laminate composed of a polycarbonate sheet, layers of tertiary butyl styrene resin, and at least one glass sheet. One layer of tertiary butyl styrene resin is adhered to each opposing side of the polycarbonate sheet. The glass sheets, in turn, are bonded to each layer of tertiary butyl styrene resin. A highly flexible silicone adhesive may be utilized to glue the laminate to a window frame.

Another kind of security window offers protection against incoming projectiles by utilizing a window pane with a gap and internal chambers. This window pane includes a frame composed of metallic profiled sections. The metallic profiled sections delimit the gap, which has a stepped configuration. In use, a projectile moving toward the window pane may enter the gap, but it is promptly deflected by the stepped configuration of the gap. The window pane also has internal chambers delimited by inclined surfaces that extend at an acute angle with respect to a side of the window pane. When a projectile penetrates any of these internal chambers, it is deflected upon contacting the inclined surfaces delimiting the respective internal chamber. After the projectile has been deflected, other parts of the window pane stop the penetrating projectile.

In addition to the window designs described above, many other designs have been developed throughout the years. Nonetheless, improvements are always possible.

### SUMMARY

The present disclosure relates to a security window for shielding a secured space from forceful attacks. An embodiment of the presently disclosed security window includes a fixed lateral profile, a pane, a pane profile movably mounted on the fixed lateral profile, and a locking mechanism is configured to secure the pane profile to the fixed lateral profile. The pane profile supports the pane and is adapted to move the pane between open and closed positions. The locking mechanism has locked and unlocked positions and includes a movable profile adapted to slide longitudinally and transversely with respect to the fixed lateral profile. The movable profile is positioned between the fixed lateral profile and the pane profile when the locking mechanism is in the locked position. When the locking mechanism is in the unlocked position, the movable profile is located inside the pane profile.

In an alternative embodiment, the security window includes a first fixed lateral profile, a second fixed lateral profile, a pane, a pane profile including first and second columns, and a a plurality of locking mechanisms operatively associated with the first and second columns of the pane profile. The first and second columns are movably mounted on the respective first and second fixed lateral profiles. The pane profile encloses the pane and is adapted to move the pane between open and closed position. Each locking mechanism has locked and unlocked positions. Further, each locking mechanism is configured to secure the pane profile to the first and second fixed lateral profiles and includes a movable profile adapted to slide longitudinally and transversely with respect to the fixed lateral profile. The movable profile is positioned between the pane profile and at least one of the first and second fixed lateral profiles when locking mechanism is in the locked position. When the locking mechanism is in the unlocked position, the movable profile is located inside the pane profile.

### BRIEF DESCRIPTION OF THE DRAWINGS

Various embodiments of the presently disclosed security window are described herein with reference to the drawings, wherein:

FIG. 1 is a rear perspective view of a security window according to an embodiment of the present disclosure;

FIG. 2 is a side cross-sectional view of the security window of FIG. 1;

FIG. 3 is a top plan view of the security window of FIG. 1;

FIG. 4 is a rear perspective view of a pane and a pane profile of the security window of FIG. 1;

FIG. 5 is a cross-sectional perspective view of the security window of FIG. 1;

FIG. 6 is a side cross-sectional view of the of the security window of FIG. 1 with a first pane profile located in an open position;

FIG. 7 is a side cross-sectional view of the security window of FIG. 1 with a fastening device located in an unlocked position;

FIG. 8 is a side cross-sectional view of the security window of FIG. 1 with a second pane profile located in an open position;

FIG. 9 is a cross-sectional perspective view of the security window of FIG. 1 with the second pane profile located in an open position;

FIG. 10 is a cross-sectional perspective view of a portion of the security window of FIG. 1 showing the inner components of the second pane profile;

FIG. 11 is a cross-sectional perspective view of a portion of the security window of FIG. 1 showing the internal components of the first and second pane profiles;

FIG. 12 is a perspective view of a locking mechanism of the security window of FIG. 1;

FIG. 13 is a side plan view of the locking mechanism of FIG. 12;

FIG. 14 is an exploded perspective view of the locking mechanism of FIG. 12;

FIG. 15 is a top perspective view of the locking mechanism of FIG. 12;

FIG. 16 is a top perspective view of the locking mechanism of FIG. 12 showing the internal components of the locking mechanism;

FIG. 17 is a top perspective view of a portion of the security window of FIG. 1 showing the locking mechanism in a locked position;

FIG. 18 is a top cross-sectional view of the locking mechanism of FIG. 12 without a handle;

FIG. 19 is a top cross-sectional view of the internal components of the locking mechanism of FIG. 12 moving toward the locked position;

FIG. 20 is a top cross-sectional view of the locking mechanism of FIG. 12 without the handle moving toward the locked position;

FIG. 21 is a perspective view of the locking mechanism of FIG. 12 showing the handle moving toward the locked position;

FIG. 22 is a perspective view of a portion of the security window of FIG. 1 showing one locking mechanism in a locked position and another locking mechanism in an unlocked position; and

FIG. 23 is a perspective view of a portion of the locking mechanism of FIG. 12 showing the internal components in the locked position.

### DETAILED DESCRIPTION OF THE EMBODIMENTS

Embodiments of the presently disclosed security window will now be described in detail with reference to the drawings in which like reference numerals designate identical or corresponding elements in each of the several views. Throughout this disclosure, the term “outer” refers to the side of the window subject to a forceful attack by natural elements or humanly created threats, while the term “inner” refers to the side of the window facing a secured space.

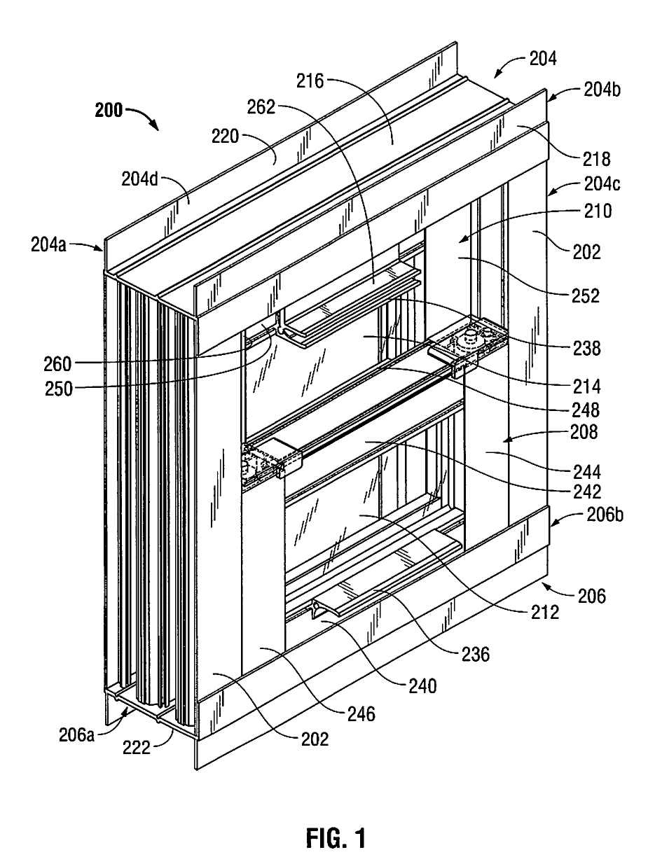

With reference to FIGS. 1-3, an embodiment of the presently disclosed security window is designated as 200. Security window 200 may be a double hung type window, as shown in the drawings, or any other suitable kind of window. In the depicted embodiment, security window 200 generally includes a pair of fixed jambs or lateral profiles 202, a header 204, and a sill 206. Fixed lateral profiles 202, header 204, and sill 206 collectively surround and support first and second sashes or pane profiles 208, 210. First and second pane profiles 208, 210, in turn, support first and second panes 212, 214, respectively. First and second panes 212, 214 may be made of tempered glass or any other suitable material. During operation, each pane profile 208, 210 is capable of sliding between an open position and a closed position, as discussed in detail below.

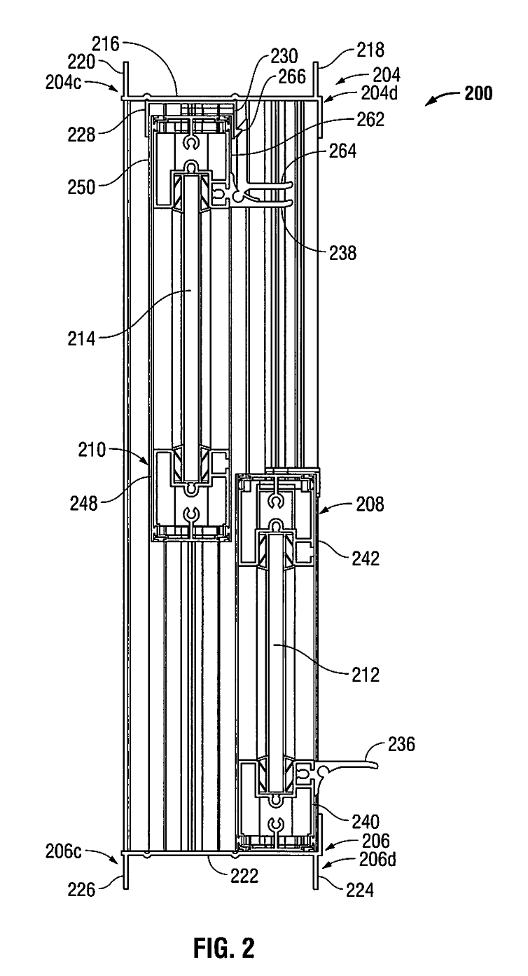

Header 204 has first and second ends 204a, 204b. Each end 204a, 202b is operatively attached to a fixed lateral profile 202. Header 204 additionally includes a connecting panel 216 extending between first and second ends 204a, 204b and transversely interconnecting an inner panel 218 and an outer panel 220. Inner panel 218 is located on an inner portion 204c of header 204, whereas outer panel 220 is positioned on an outer portion 204d of header 204. Inner panel 218 covers a portion of each fixed lateral profile 202, thereby inhibiting the penetration of fluids, projectiles, and other foreign objects through security window 200. As seen in FIG. 2, header 204 also includes a sleeve 228 attached to connecting panel 216. Sleeve 228 has an engagement protrusion 230 and is adapted to receive second pane profile 210. Engagement protrusion 230 is configured to engage a fastening device 262, as discussed in detail below.

Sill 206 has first and second ends 206a, 206b operatively attached to respective fixed lateral profiles 202. In addition, sill 206 includes a connecting panel 222 extending between first and second ends 206a, 206b and interconnecting an inner panel 224 and an outer panel 226. Outer panel 226 is located on an outer portion 206c of sill 206, and inner panel 224 is positioned on an inner portion 206d of sill 206. Inner panel 224 covers a portion of each fixed lateral profile 202, thus hindering the penetration of fluids, projectiles, and other foreign objects through security window 200.

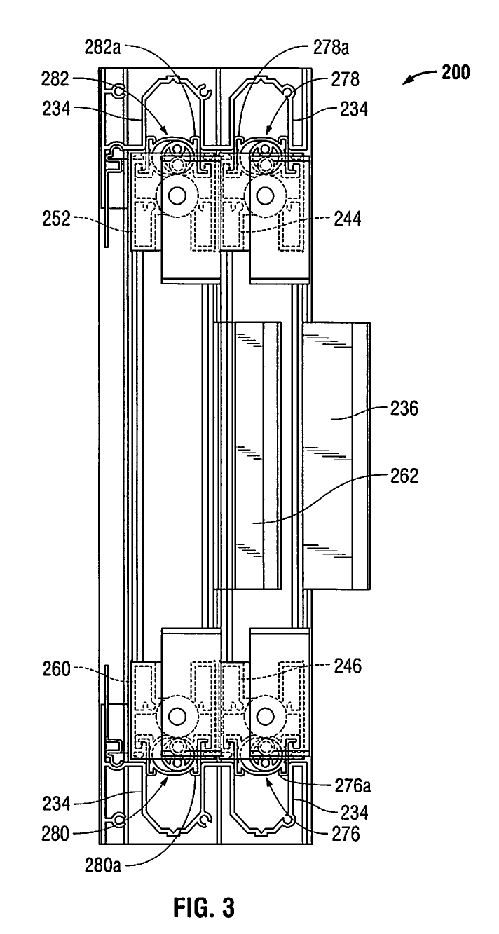

As discussed hereinabove, security window 200 further includes a couple of fixed lateral profiles 202 placed at opposite sides thereof. Each fixed lateral profile 202 is operatively attached to header 204 and sill 206. As illustrated in FIG. 3, each fixed lateral profile 202 has a pair of guides 234 configured to slidably receive a lateral portion 276a, 278a, 280a, 282a of movable profiles 276, 278, 280, 282. Movable profiles 276, 278, 280, 282 extend along substantially the entire length of guides 234, thereby enhancing the protection against fluids infiltration and forceful attacks. Moreover, movable profiles 276, 278, 280, 282 may be made using CNC machining techniques or by any other suitable methods.

First pane profile 208 supports a first pane 212 and a second pane profile 210 supports a second pane 214. As seen in FIG. 2, first and second pane profiles 208, 210 are disposed substantially parallel to each other. Particularly, first pane profile 208 contains first and second beams 240, 242, and first and second columns 244, 246. Beams 240, 242 and columns 244, 246 are interconnected to one another to form a support framework around first pane 212. Similarly, second pane profile 210 contains first and second beams 248, 250, and first and second columns 252, 260. Beams 248, 250 and columns 252, 260 together form a support framework around second pane 214.

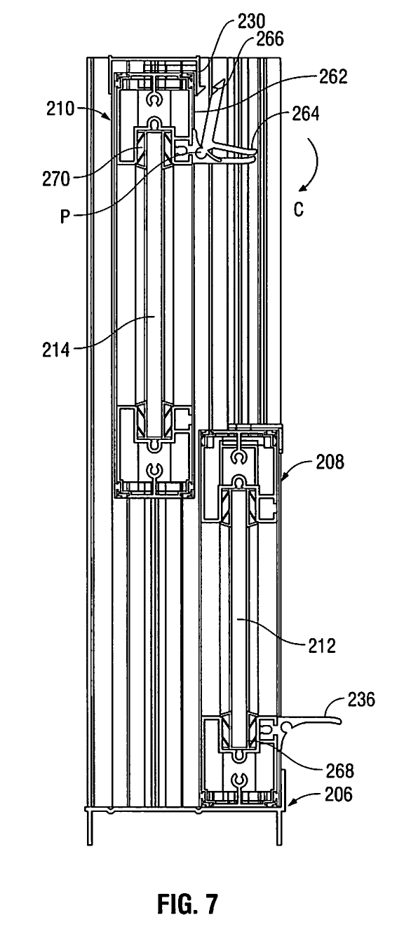

Each pane profile 208, 210 has a handle 236, 238 fixed thereto. Specifically, handle 236 is operatively coupled to first beam 240 of first pane profile 208, and handle 238 is operatively attached to second beam 250 of second pane profile 210. Handle 238 includes a fastening device 262 pivotably connected thereto. Fastening device 262 has a lever 264 and a notch 266 capable of engaging protrusion 230. During operation, a user disengages fastening device 262 from protrusion 230 by moving lever 264, as shown in FIG. 7.

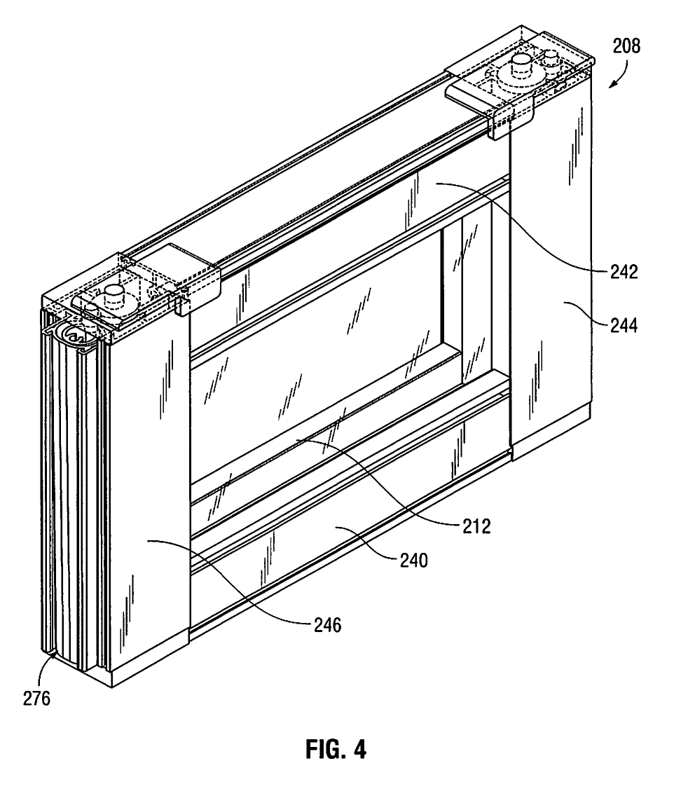

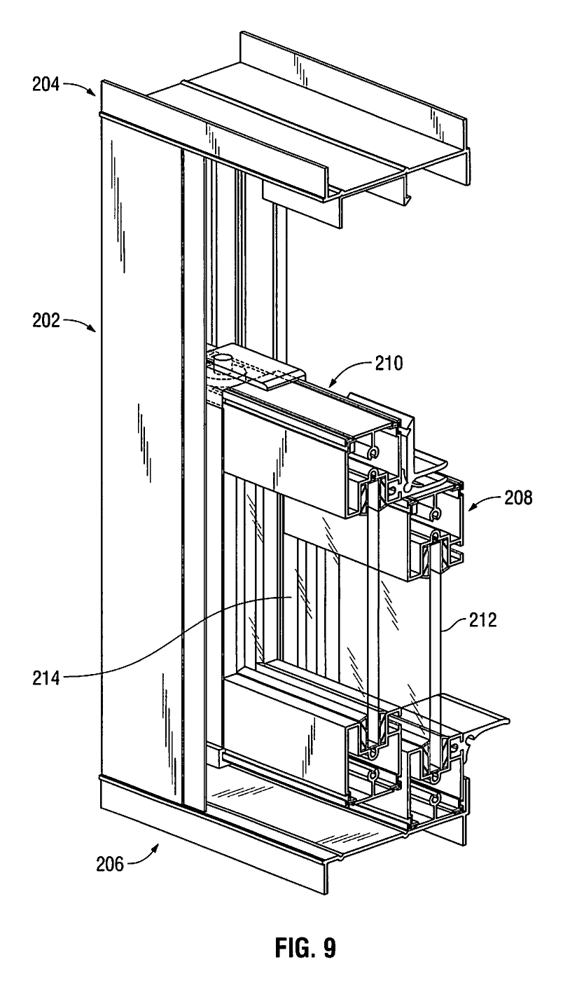

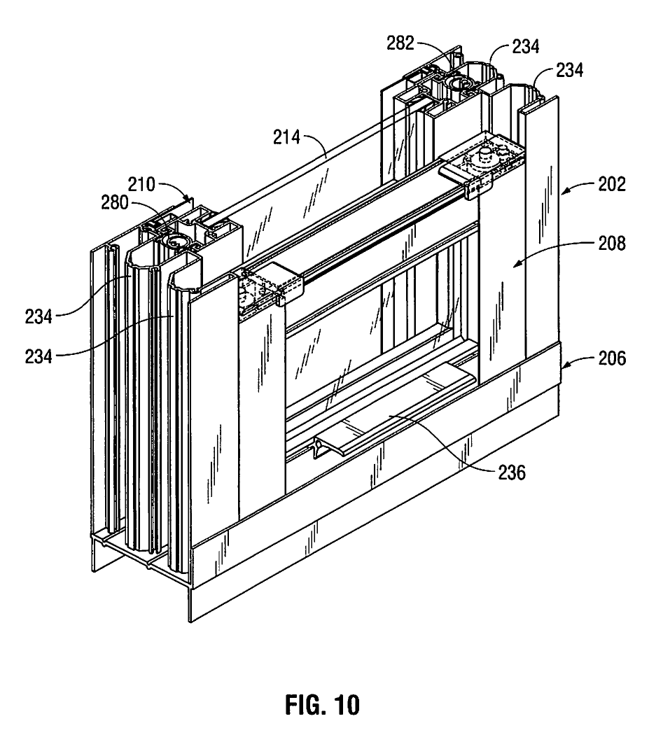

Referring to FIGS. 4-11, first and second pane profiles 208, 210 each incorporate a recess 268, 270 positioned around their respective central periphery. Each recess 268, 270 is dimensioned to receive a corresponding pane 212, 214. In one embodiment, recesses 268, 270 include angled retaining members 272, 274 positioned therein, as illustrated in FIG. 25. Retaining members 272, 274 facilitate the retention of panes 212, 214 within pane profiles 208, 210.

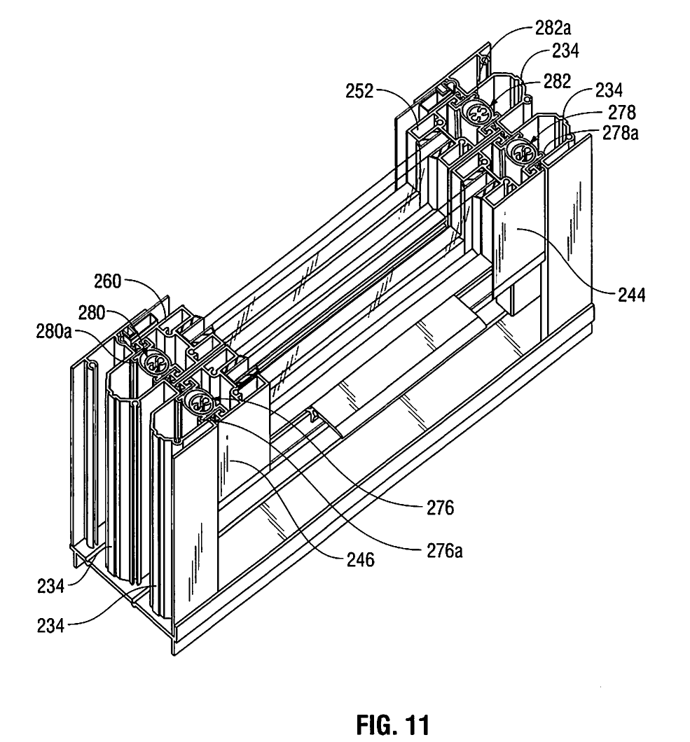

Security window 200 further includes first, second, third, and fourth movable profiles 276, 278, 280, 282 disposed in mechanical cooperation with a corresponding pane profile 208, 210, as seen in FIG. 11. In particular, first movable profile 276 is operatively secured to column 246 of first pane profile 208. Second movable profile 278 is operatively coupled to column 244 of first pane profile 208. Third movable profile 280 is operatively attached to column 260 of second pane profile 210. Fourth movable profile 282 is operatively connected to column 252 of second pane profile 210. As illustrated in FIGS. 22 and 30, a lateral portion 276a, 278a, 280a, 282a of each movable profile 276, 278, 280, 282 is slidably positioned within a corresponding guide 234 of a lateral profile 202.

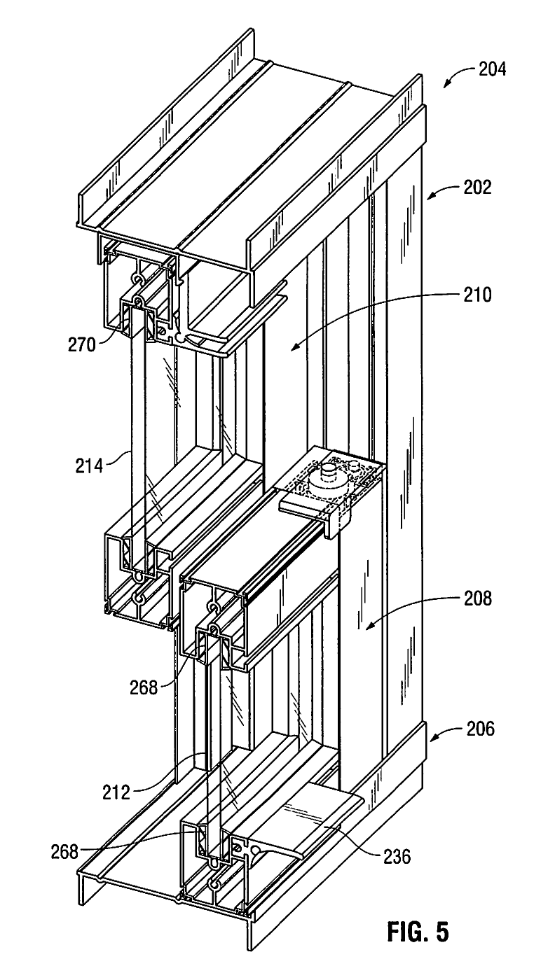

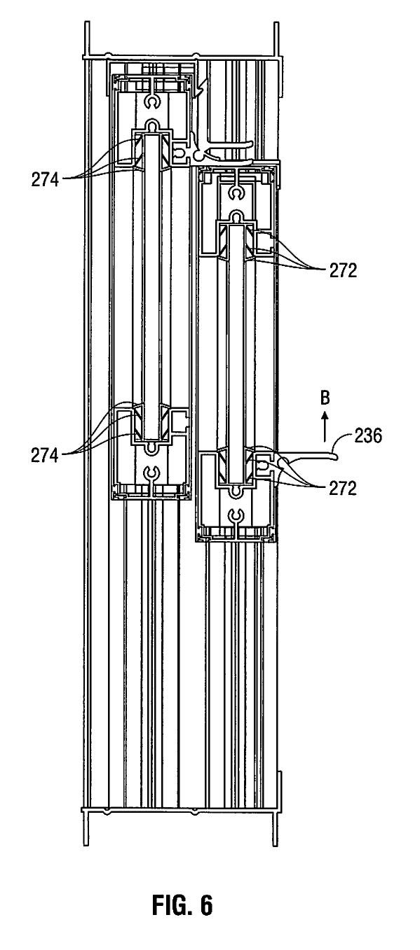

During operation, first, second, third and fourth movable profile 276, 278, 280, 282 slide along a respective guide 234 to move first and second pane profiles 208, 210 between a closed position and an open position. A user can move first pane profile 208 from a closed position (see FIG. 5) to an open position (see FIG. 6) by manually pushing handle 236 in the direction indicated by arrow “B” in FIG. 6. As first panel profile 208 moves, first and second movable profiles 276, 278 translate along the corresponding guide 236 of lateral profiles 202. Therefore, guides 236 direct the movement of first and second movable profiles 276, 278 alongside lateral profiles 202.

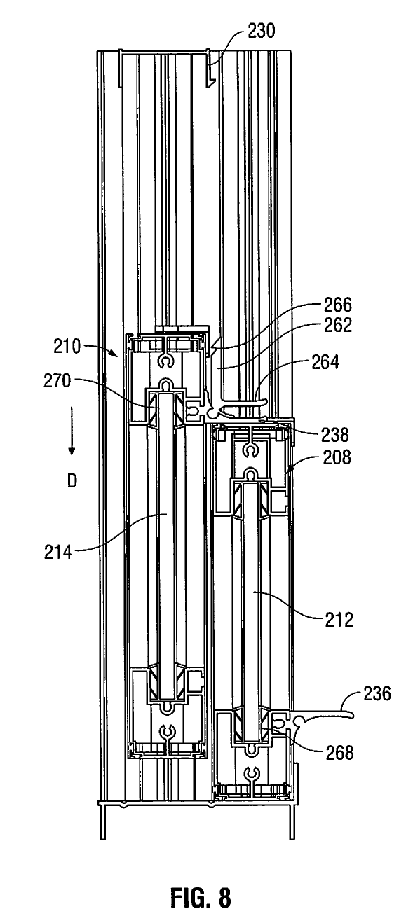

The operation of second pane profile 210 is similar to the operation of first pane profile 208. A user can move second pane profile 210 between a closed position (see FIG. 7) and an open position (see FIG. 8). However, in order to move second pane profile 210, fastening device 262 must be first disengaged from engagement protrusion 230. To disengage fastening device 262, the user moves lever 264 of fastening device 262 in the direction indicated by arrow “C” in FIG. 7. As the lever 264 moves, fastening device 262 pivots about a pivot point “P” and notch 266 disengages engagement protrusion 230. Once fastening device 262 has been disengaged from engagement protrusion 230, second pane profile 210 can freely move from a closed position toward an open position. The user then moves axially second pane profile 210 along lateral profiles 202 by pushing handle 238 in the direction indicated by arrow “D” in FIG. 8. As second pane profile 210 translates, third and fourth movable profiles 280, 282 slide through corresponding guides 234 of lateral profiles 202. Guides 234 thus direct the motion of third and fourth movable profiles 280, 282 alongside lateral profiles 202. Eventually, second pane profile 210 reaches the open position, as illustrated in FIGS. 8-10.

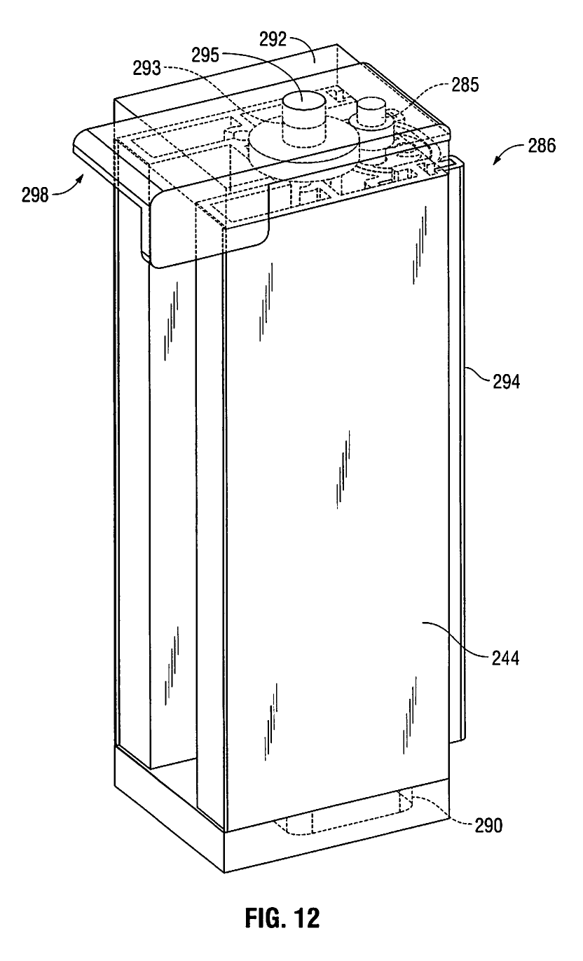

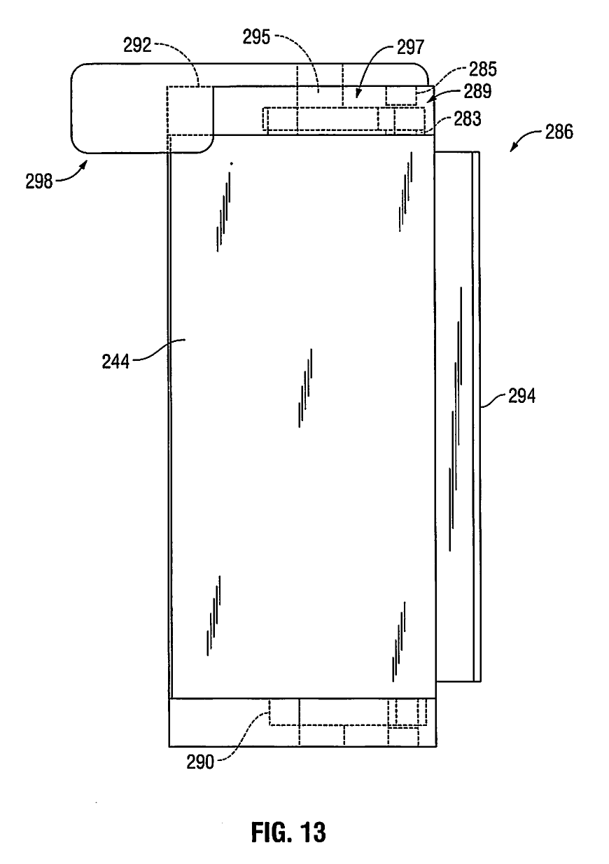

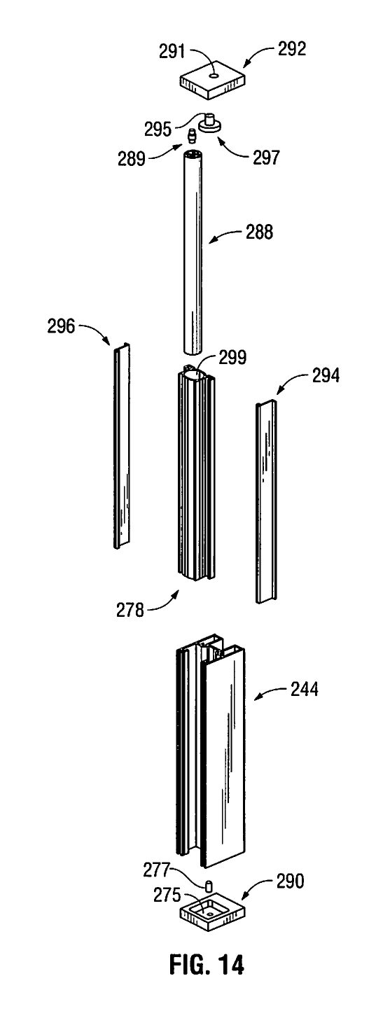

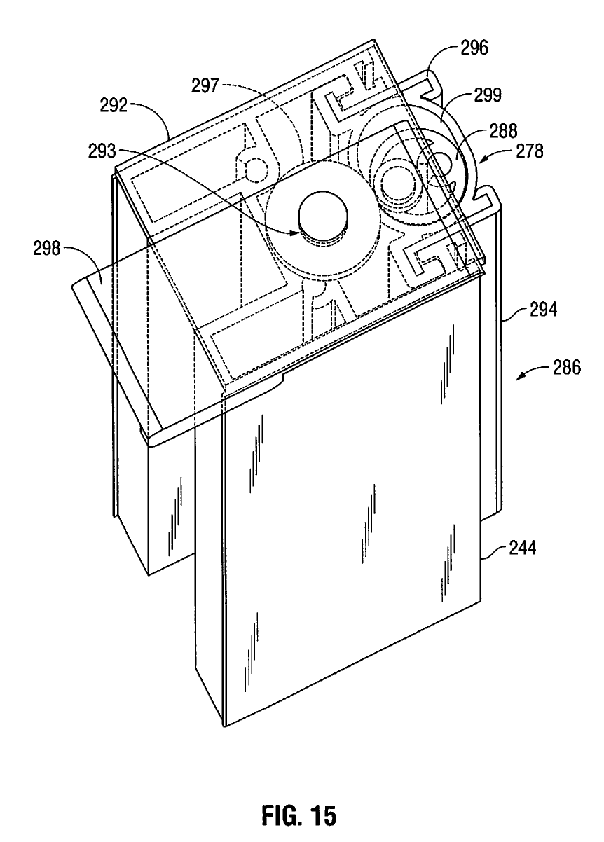

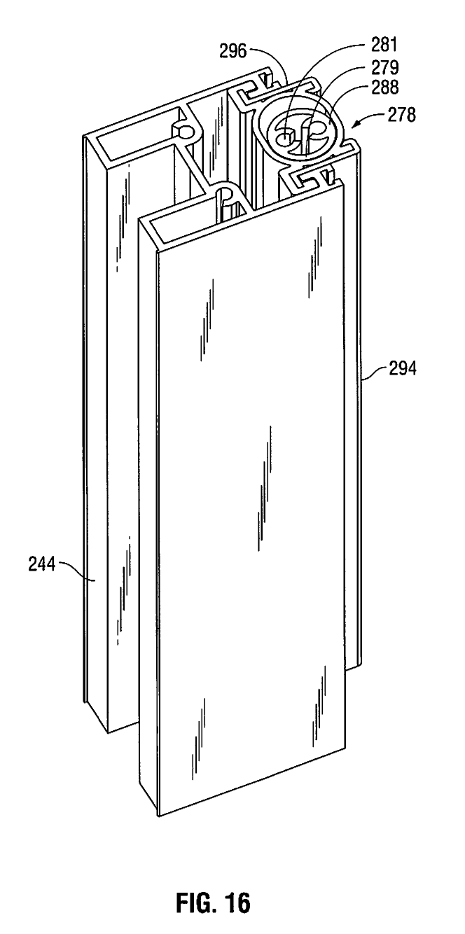

With reference to FIGS. 12-16, column 244 of first pane profile 208 partially houses a locking mechanism 286. Columns 246 of first pane profile 208 and columns 252, 260 of second pane profile 210 also partially encompass a locking mechanism 286. Since the construction and operation of the locking mechanism 286 disposed in columns 246, 252, 260 is substantially similar to the locking mechanism 286 disposed in column 244, the present disclosure will only discuss the construction and operation of locking mechanism 286 partially positioned in column 244.

Second movable profile 278 is part of locking mechanism 286. Additionally, locking mechanism 286 includes a tubular member 288, a base 290, a cover 292, a pair of sliding members 294, 296, and a handle 298. Second movable profile 278 is fixed to column 244 of first pane profile 208 and has a bore 299 extending therethrough. Bore 299 is adapted to receive tubular member 288. Handle 298 sits on cover 292 and is operatively connected to tubular member 288. In the depicted embodiment, a first roller 297 having a tubular portion 295 couples handle 298 to cover 292. Both handle 298 and cover 292 have respective holes 293, 291 dimensioned to receive tubular portion 295 of first roller 297. Cover 292 also has an opening 287 adapted to receive a first tubular portion 285 of a second roller 289. First roller 297 is disposed in mechanical cooperation with second roller 289. In operation, the rotation of first roller 297 causes the rotation of second roller 289. Second roller 289 further includes a second tubular portion 283 rotatably mounted to tubular member 288. Second tubular portion 283 of second roller 289 is specifically positioned in a slot 281 located on an internal surface 279 of tubular member 288. Slot 281 is an elongate structure that extends along substantially the entire length of internal surface 279. A pin 277 positioned in slot 281 connects base 290 to tubular member 299. Base 290 has an opening 275 configured to receive pin 277.

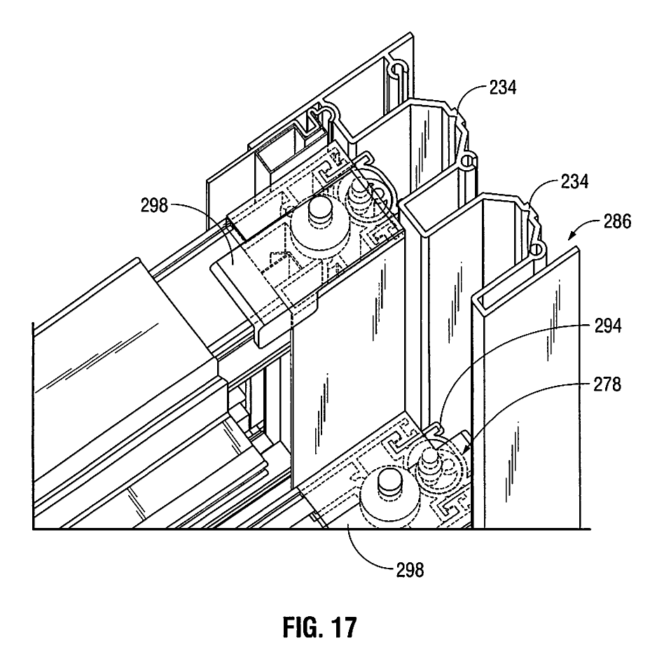

Moreover, locking mechanism 286 also has sliding members 294, 296 located at opposite sides of second movable profile 278. In operation, sliding members 294, 296 slide longitudinally along guide 234 when first pane profile 208 moves between an open position and a closed position, as seen in FIG. 17. In addition, sliding members 294, 296 slide transversely with respect to guide 234 when locking mechanism 286 moves from an unlocked position toward a locked position as discussed in detail below.

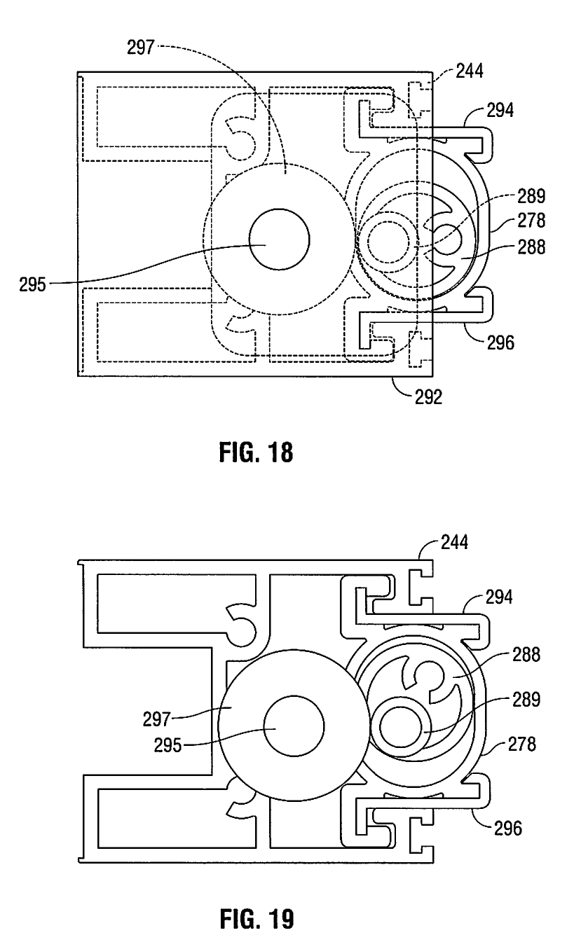

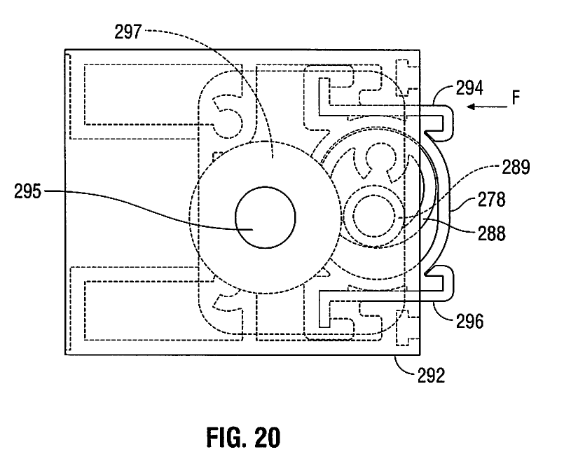

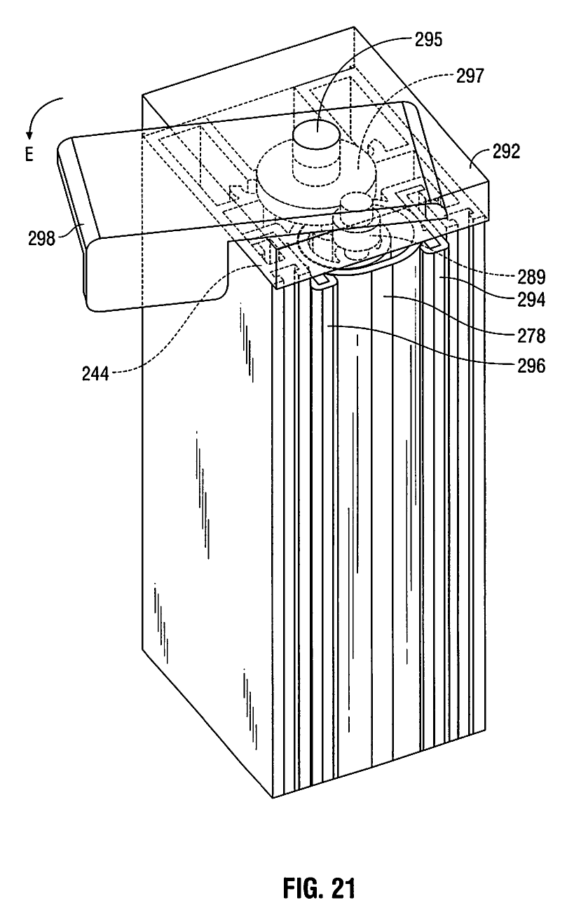

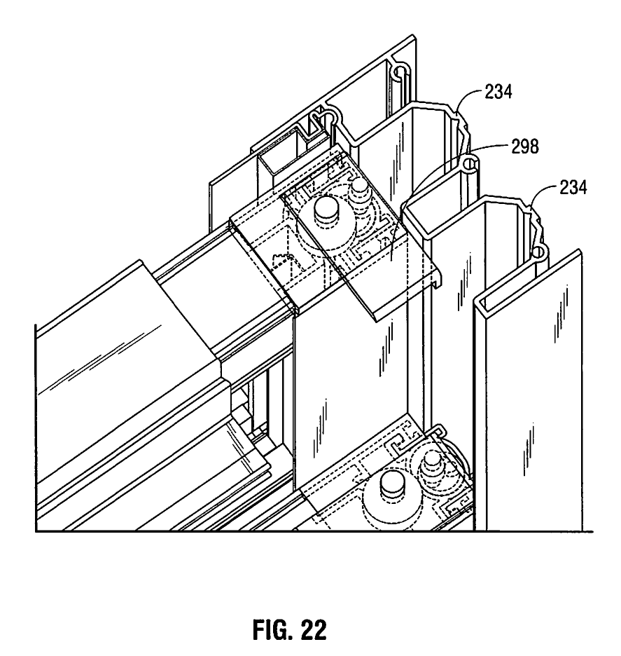

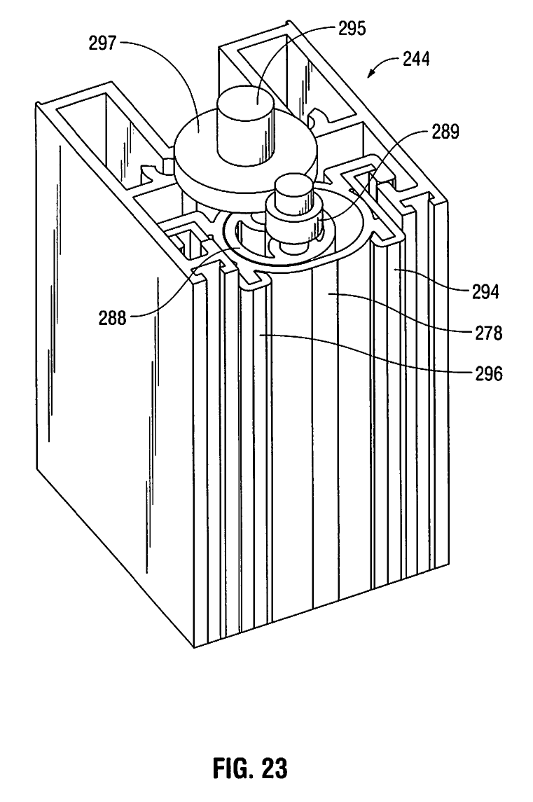

With reference to FIGS. 17-23, when locking mechanism 286 is in the locked position, sliding members 294, 296 are disposed within guide 234, as seen in FIG. 17, and tubular member 288 is located in a first position, as illustrated in FIG. 18. To unlock locking mechanism 286, a user moves handle 298 in the direction indicated by arrow “E” in FIG. 21. At this moment, handle 298 pivots about tubular portion 295 of first roller 297. The pivotal motion of handle 298 causes the rotation of first roller 297. In turn, the rotation of first roller 297 causes the rotary motion of second roller 289. As second roller 289 rotates, tubular member 288 pivots within second movable profile 278 about second roller 289, as shown in FIGS. 19 and 20. The pivotal motion of tubular member 288 causes second movable profile 278 to move in the direction indicated by arrow “F” in FIG. 20. Consequently, sliding members 294, 296 slide transversely with respect to guide 234 and position locking mechanism 286 in the unlocked position as seen in FIG. 22. When the locking mechanism 286 is in the unlocked position, sliding members 294, 296 and second movable profile 278 are located outside of guide 234 and tubular member 288 is located in a second position, as seen in FIGS. 22 and 23. After locking mechanism 286 has been unlocked, a user can detach second pane profile 208 from fixed lateral profiles 202.

It will be understood that various modifications may be made to the embodiments disclosed herein. Therefore, the above description should not be construed as limiting, but merely exemplifications of embodiments. Those skilled in the art will envision other modifications within the scope and spirit of the present disclosure.

What is claimed is:

1. A security window, comprising:
a fixed lateral profile;
a pane;
a pane profile movably mounted on the fixed lateral profile, wherein the pane profile supports the pane and is adapted to move the pane between open and closed positions; and
a locking mechanism configured to secure the pane profile to the fixed lateral profile, the locking mechanism having locked and unlocked positions, the locking mechanism including:
a movable profile adapted to slide longitudinally and transversely with respect to the fixed lateral profile, wherein the movable profile is positioned between the fixed lateral profile and the pane profile when locking mechanism is in the locked position and, when the locking mechanism is in the unlocked position, the movable profile is located inside the pane profile.

2. The security window according to claim 1, wherein the movable profile is configured to slide longitudinally along the fixed lateral profile to move the pane between the open and closed positions.

3. The security window according to claim 1, further comprising a header connected to the fixed lateral profile.

4. The security window according to claim 1, wherein the lateral profile includes a guide for directing the movement of the movable profile along the fixed lateral profile.

5. The security window according to claim 4, wherein the movable profile includes a pair of sliding members arranged in diametrical opposed relation to each other, the pair of sliding member being adapted to slide along the guide of the lateral profile.

6. The security window according to claim 1, wherein the movable profile includes a bore extending therethrough.

7. The security window according to claim 1, wherein the locking mechanism includes a tubular member positioned within the bore of the movable profile.

8. The security window according to claim 7, wherein the locking mechanism includes a handle, a first roller operatively coupled to the handle, and a second roller operatively connected to the first roller and the tubular member such that rotation of the first roller through the handle causes the second roller to rotate and move tubular member relative to the fixed lateral profile.

9. The security window according to claim 8, wherein the pane profile includes a first beam, a second beam, a first column and a second column collectively enclosing the pane, the movable profile being positioned at least partially within the first column.

10. The security window according to claim 1, further comprising a fastening device configured to releaseably secure the pane in the closed position.

11. The security window according to claim 1, further comprising a sill connected to the fixed lateral profile.

12. A security window, comprising:
a first fixed lateral profile;
a second fixed lateral profile;
a pane;
a pane profile including first and second columns, the first and second columns being movably mounted on the respective first and second fixed lateral profiles, wherein the pane profile encloses the pane and is adapted to move the pane between open and closed positions; and
a plurality of locking mechanisms operatively associated with the first and second columns of the pane profile, each locking mechanism having locked and unlocked positions, wherein each locking mechanism is configured to secure the pane profile to the first and second fixed lateral profiles and includes:
a movable profile adapted to slide longitudinally and transversely with respect to the fixed lateral profile, wherein the movable profile is positioned between the pane profile and at least one of the first and second fixed lateral profiles when locking mechanism is in the locked position and, when the locking mechanism is in the unlocked position, the movable profile is located inside the pane profile.

13. The security window according to claim 12, wherein the movable profile is configured to slide longitudinally along the fixed lateral profile to move the pane between the open and closed positions.

14. The security window according to claim 12, further comprising a header connected to the first and second fixed lateral profiles.

15. The security window according to claim 12, wherein at least one of the first and second lateral profiles includes a guide for directing the movement of the movable profile along at least one of the first and second fixed lateral profiles.

16. The security window according to claim 15, wherein the movable profile includes a pair of sliding members arranged in diametrical opposed relation to each other, the pair of sliding member being adapted to slide along the guide of at least one of the first and second lateral profiles.

17. The security window according to claim 12, wherein the movable profile includes a bore extending therethrough.

18. The security window according to claim 12, wherein the locking mechanism includes a tubular member positioned within the bore of the movable profile.

19. The security window according to claim 18, wherein the locking mechanism includes a handle, a first roller operatively coupled to the handle, and a second roller operatively connected to the first roller and the tubular member such that rotation of the first roller through the handle causes the second roller to rotate and move tubular member relative to at least one of the first and second fixed lateral profiles.

20. The security window according to claim 19, wherein the pane profile includes first and second beams connected to the first and second columns.

21. The security window according to claim 12, further comprising a fastening device configured to releaseably secure the pane in the closed position.

22. The security window according to claim 12, further comprising a sill connected to the first and second fixed lateral profiles.
